(19) United States
(12) Patent Application Publication
(10) Pub. No.: US 2015/0364154 A1
(43) Pub. Date: Dec. 17, 2015

(54) REDUCED CONTACT READ/WRITE HEAD

(71) Applicant: HEWLETT-PACKARD DEVELOPMENT COMPANY, L.P., Houston, TX (US)

(72) Inventors: Mike Alan Holmberg, Boise, ID (US); Brian Brong, Boise, ID (US); Paul W. Poorman, Boise, ID (US)

(21) Appl. No.: 14/763,953

(22) PCT Filed: Mar. 22, 2013
(86) PCT No.: PCT/US13/33483

§ 371 Date: Jul. 28, 2015

(51) Int. Cl. G11B 15/62; G11B 5/008

(52) U.S. Cl. CPC G11B 15/62; G11B 5/00826

(57) ABSTRACT

A system including a read/write head to write to a magnetic tape. The read/write head includes a data island that includes read/write elements. The data island to reduce contact between the magnetic tape and the data island at locations between the read/write elements.

### BACKGROUND

Magnetic tape data storage uses digital recordings on magnetic tape to store digital information. Often, magnetic tape is used for offline, archival data storage, where magnetic tape is the primary copy of stored data. Generally, magnetic tape is cost effective and has long archival stability, such as thirty years or more.

Often, magnetic tape is packaged in tape cartridges or tape cassettes. Tape drives include one or more read/write heads to read data from and write data to these tapes. Autoloaders and tape libraries store the tapes and automate tape handling.

### BRIEF DESCRIPTION OF THE DRAWINGS

FIG. 1 is a diagram illustrating one example of a data storage system in accordance with an example of the techniques of the present application.

FIG. 2 is a diagram illustrating one example of a read/write head and a magnetic tape in accordance with an example of the techniques of the present application.

FIG. 3 is a diagram illustrating one example of a read/write head including two data islands and two outriggers in accordance with an example of the techniques of the present application.

FIG. 4 is a diagram illustrating one example of a data island that includes four read/write elements and slots in accordance with an example of the techniques of the present application.

FIG. 5 is a diagram illustrating one example of a data island that includes four read/write elements coated with coating material to provide slots in accordance with an example of the techniques of the present application.

FIG. 6 is a diagram illustrating one example of a data island that includes four read/write elements and has sharp edges and rounded edges in accordance with an example of the techniques of the present application.

FIG. 7A is a diagram illustrating one example of a data island that includes four read/write elements on read/write platforms and platform slots in accordance with an example of the techniques of the present application.

FIG. 7B is a diagram illustrating one example of a cross section of the data island of FIG. 7A taken along the line A-A.

FIG. 8A is a diagram illustrating one example of a data island that has rounded edges and includes read/write elements on read/write platforms and platform slots in accordance with an example of the techniques of the present application.

FIG. 8B is a diagram illustrating one example of a cross section of the data island of FIG. 8A taken along the line B-B.

FIG. 9 is a diagram illustrating one example of a data island that includes four read/write elements and data island substrate material in accordance with an example of the techniques of the present application.

FIG. 10 is a diagram illustrating one example of coating material applied over a data island substrate material and read/write elements in accordance with an example of the techniques of the present application.

FIG. 11 is a flow-chart diagram illustrating one example of manufacturing a data island in accordance with an example of the techniques of the present application.

### DETAILED DESCRIPTION

In the following detailed description, reference is made to the accompanying drawings which form a part hereof, and in which is shown by way of illustration specific embodiments in which the techniques of the present application may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the techniques of the present application. The following detailed description, therefore, is not to be taken in a limiting sense. It is to be understood that features of the various embodiments described herein may be combined with each other, unless specifically noted otherwise.

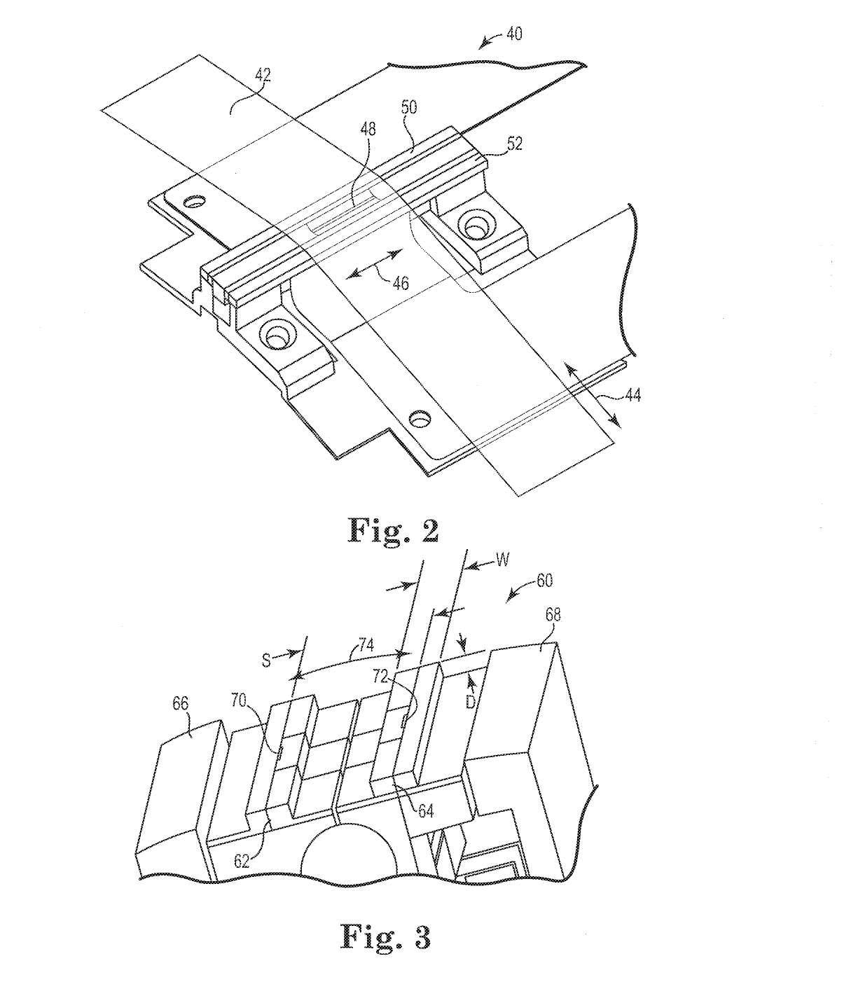

In one example, to read from and write to a magnetic tape, a read/write head of a tape drive moves from side to side in relation to the magnetic tape, i.e., the read/write head moves orthogonal to the direction of travel of the magnetic tape as shown in FIG. 2. The read/write head and the magnetic tape are spaced as closely as possible to each other to increase the read/write signal to noise ratio and to increase the data storage density on the magnetic tape. This spacing is referred to as the magnetic spacing between the read/write head and the magnetic tape. In one example, closer magnetic spacing can be achieved through smoother surfaces on the read/write head and/or on the magnetic tape. However, increased smoothness, i.e., reduced roughness, of the read/write head and/or the magnetic tape can increase friction and drag between the read/write head and the magnetic tape. In one example, this increase in friction and drag can cause the magnetic tape to move sideways with the read/write head, making track positioning and following difficult or impossible, where in severe cases the magnetic tape can even stick to the read/write head, leading to damage, broken tapes, inability to remove the tape cartridge from the tape drive, and/or loss of customer data. In one example, as described herein, the surface contact area between the read/write head and the magnetic tape can be reduced, which can reduce friction and drag between the read/write head and the magnetic tape.

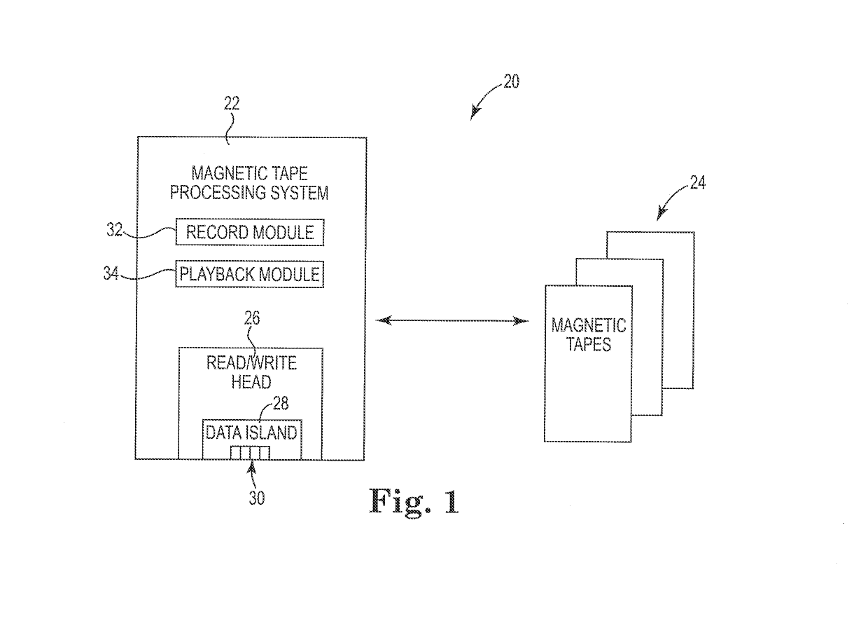

FIG. 1 is a diagram illustrating one example of a data storage system 20 that includes a magnetic tape processing system 22 and magnetic tapes 24. In one example, data storage system 20 can be configured as an open-format tape system, where the term open-format means users have access to multiple sources of compatible storage media products. In one example, data storage system 20 can be configured to operate as a linear tape open (LTO) data storage system. In one example, data storage system 20 can be configured to operate as an LTO-7 or higher generation data storage system. In one example, data storage system 20 can be configured to operate as an LTO-7 or higher generation data storage system that is backward compatible to at least one generation. In one example, magnetic tapes 24 can include a cartridge to house magnetic medium to record data in a magnetic form and playback the stored data.

In one example, tape processing system 22 includes a read/write head 26 that reads from and writes to each of the magnetic tapes 24. Read/write head 26 includes at least one data island 28 that includes multiple read/write elements 30, The data island 28 supports read/write elements 30. Each of the read/write elements 30 can be configured to read from and write to each of the magnetic tapes 24. in one example, data island 28 can include 16 or more read/write elements 30. In one example, at least one of the read/write elements 30 can include magneto-resistance (MR) type elements, such as anisotropic magneto-resistance (AMR) elements, tunneling magneto-resistance (TMR) elements, giant magneto-resistance (GMR) elements, current perpendicular giant magneto-resistance (CPPGMR) elements, and/or colossal magneto-resistance (CMR) elements.

In one example, an MR type element can be used for writing or recording data to magnetic tape and can include a device having the properties of changing resistance when a magnetic field is presented to the device. In one example, MR elements can be configured or incorporated into recording head structures, such as read/write head 26 and read/write elements 30, allowing for differing response ratios for a given magnetic field depending on factors such as biasing design, shield to shield spacing, electrical current density, and other factors. In another example, GMR, TMR, and CMR magneto-resistive recording devices are also known as spin-valve type devices since they utilize the electron spin in the material to derive their magneto-resistive response.

In one example, to read from and write to one of the magnetic tapes 24, read/write head 26 can move from side to side, across the surface of the magnetic tape, in relation to the magnetic tape. In one example, read/write head 26 moves from side to side to provide a large number of tracks, such as thousands of tracks across the magnetic tape.

In one example, magnetic tape processing system 22 can include a record module 32 configured to perform a record process that includes writing data to magnetic tapes 24. The record module 32 can be implemented in hardware, software, or a combination thereof. In one example, the record module 32 can receive from a host or other electronic device requests to write data to a magnetic tape. The record module 32 can cause the magnetic tape 24 to move past read/write head 26 to write data to the magnetic tape. In another example, record module 32 can cause a top surface of the magnetic tape to be positioned underneath the bottom surface of read/write elements 30 to allow read/write elements 30 to write data to the magnetic tape. The record module 32 can translate the data from an electronic form into a magnetic form that can be written to a magnetic tape, such as one of the magnetic tapes 24.

In another example, magnetic tape processing system 22 can include a playback module 34 configured to perform a read or playback process that includes reading data from magnetic tapes 24. The playback module 34 can be implemented in hardware, software, or a combination thereof. In one example, playback module 34 can receive from a host or other electronic device requests to read data from a magnetic tape. The playback module 34 can cause the magnetic tape to move past read/write head 26 to read data from the magnetic tape. In one example, playback module 34 can cause a top surface of the magnetic tape to be positioned underneath the bottom surface of read/write elements 30. The playback module 34 can translate data in a magnetic form from magnetic tape into an electronic form. In one example, read/write elements 30 can include a PRML channel and an MR read element to help translate magnetic information from magnetic tape to electronic form. In another example, playback module 34 can include read amplifier functionality to help amplify the translated electronic data. In another example, playback module 34 can include read/write channel detection functionality to convert the signals to digital form to be processed by the host or other electronic device.

In one example, to reduce friction and drag between read/write head 26 and a magnetic tape of the magnetic tapes 24, the surface contact area between read/write head 26 and the magnetic tape can be reduced. The surface contact area between data island 28 and the magnetic tape can be reduced at locations between read/write elements 30. In one example, slots can be formed or provided between read/write elements 30 on data island 28. In another example, data island 28 can have or be formed with rounded edges at locations between read/write elements 30 and sharp edges at locations adjacent to read/write elements 30. In one example, data island 28 can have or be formed with platform slots, between and adjacent to read/write elements 30 on read/write platforms.

FIG. 2 is a diagram illustrating one example of a read/write head 40 and a magnetic tape 42, illustrated as a transparent magnetic tape 42. The read/write head 40 can be similar to read/write head 26 (shown in FIG. 1). The magnetic tape 42 can be similar to one or more of the magnetic tapes 24 (shown in FIG. 1).

In operation, in one example, magnetic tape 42 can be guided or advanced across read/write head 40 in the direction of travel 44 of magnetic tape 42. The magnetic tape 42 can be tensioned over read/write head 40 as it is guided or advanced in either direction of travel 44 across read/write head 40. To read from and write to magnetic tape 42, read/write head 40 moves from side to side 46 in relation to magnetic tape 42, which is substantially orthogonal to the direction of travel 44 of magnetic tape 42.

The read/write head 40 includes one or more data islands 48 and two outriggers 50 and 52. In one example, outrigger 50 is located or disposed on one side of the one or more data islands 48 and the other outrigger 52 is located or disposed on the other side of the one or more data islands 48. In one example, each of the one or more data islands 48 can include multiple read/write elements. In another example, the contour of read/write head 40, including the one or more data islands 48 and outriggers 50 and 52, can help guide magnetic tape 42 across the one or more data islands 48.

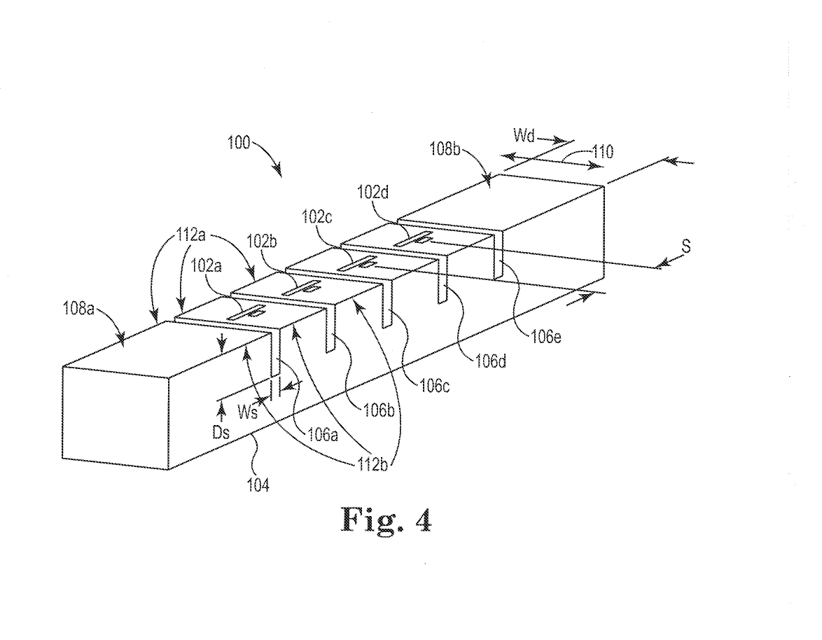

FIG. 3 is a diagram illustrating one example of a read/write head 60 including two data islands 62 and 64 and two outriggers 66 and 68. The data islands 62 and 64 are separated a distance S from the centerline of one data island 62 to the center line of the other data island 64. Each of the data islands 62 and 64 has a width W and a depth D. In one example, the distance S from the centerline of one data island 62 to the center line of the other data island 64 can be on the order of 1.0 millimeter (mm) to 1.5 mm. In one example, the width W of each of the data islands 62 and 64 can be on the order of 0.3 mm to 0.6 mm. In one example, the depth D of each of the data islands 62 and 64 can be on the order of 0.1 mm to 0.5 mm. In one example, read/write head 60 can be similar to read/write head 40 of FIG. 2.

In one example, each of the data islands 62 and 64 can include multiple read/write elements. The data island 62 can be formed to include or support read/write elements 70 and data island 64 can be formed to include or support read/write elements 72. In one example, each of the read/write elements 70 can read from and write to a magnetic tape, such as magnetic tape 42 (shown in FIG. 2), and each of the read/write elements 72 can read from and write to a magnetic tape, such as magnetic tape 42 (shown in FIG. 2). In one example, data island 62 can include 16 or more read/write elements 70. In one example, data island 64 can include 16 or more read/write elements 72. In one example, read/write elements 70 can include MR type elements, such as AMR elements, TMR elements, GMR elements, CPPGMR elements, and/or CMR elements. In one example, read/write elements 72 can include MR type elements, such as AMR elements, TMR elements, GMR elements, CPPGMR elements, and/or CMR elements.

In one example, in operation, a magnetic tape advances or travels in the direction of travel 74 across read/write head 60 from one of the outriggers 66 toward the other one of the outriggers 68 or from one of the outriggers 68 toward the other one of the outriggers 66. In one direction, data island 62 including read/write elements 70 writes to the magnetic tape and data island 64 including read/write elements 72 reads from the magnetic tape. In the other direction, data island 64 including read/write elements 72 writes to the magnetic tape and data island 62 including read/write elements 70 reads from the magnetic tape.

FIG. 4 is a diagram illustrating one example of a data island 100 that includes four read/write elements 102a-102d. In one example, each of the read/write elements 102a-102d can include an MR type element, such as an AMR element, a TMR element, a GMR element, a CPPGMR element, and/or a CMR element. In one example, data island 100 can be similar to one of the data islands 62 and 64 (shown in FIG. 3).

In one example, data island 100 includes read/write elements 102a-102d, a data island substrate material 104, and five slots 106a-106e. The slot 106a is located or formed on one side of read/write element 102a and between substrate end piece 108a and read/write element 102a. In a similar manner, slot 106b is located or formed between read/write element 102a and read/write element 102b. The slot 106c is located or formed between read/write element 102b and read/write element 102c. The slot 106d is located or formed between read/write element 102c and read/write element 102d. The slot 106e is located or formed on one side of read/write element 102d and between substrate end piece 108b and read/write element 102d. In one example, portions of data island substrate material 104 are removed to provide slots 106a-106e. In another example, portions of data island substrate material 104 are absent from between read/write elements 102a-102d to form or provide slots 106b-106d located or formed between read/write elements 102a-102d. In one example, substrate end pieces 108a and 108b are removed, such that data island 100 includes read/write elements 102a-102d and slots 106b-106d located or formed between read/write elements 102a-102d.

The data island 100 has a data island width Wd and read/write elements 102a-102d are separated a centerline spacing distance S from the centerline of one of the read/write elements 102a-102d to the center line of an adjacent one of the read/write elements 102a-102d. Each of the slots 106a-106e has a slot width Ws and a slot depth Ds. In one example, the data island width Wd can be on the order of 300 to 600 micrometers (um). In one example, the centerline spacing S of the read/write elements 102a-102d is on the order of 41 to 166 um. In one example, the slot depth Ds is on the order of 25 to 250 um. In one example, the slot width Ws is on the order of 5 to 75 um. In one example, the ratio of slot size to read/write element is 0.1 to 0.5.

In one example, to manufacture or fabricate data island 100, read/write elements 102a-102d are formed in data island substrate material 104 and slots 106a-106e are then cut into data island substrate material 104. In one example, slots 106a-106e can be cut into data island substrate material 104 to remove material by an etching process to etch data island substrate material 104. In one example, slots 106a-106e are cut into data island substrate material 104 to remove material by a mechanical process of mechanically machining slots 106a-106e into data island substrate material 104.

In one example, in operation, a magnetic tape is advanced or guided across data island 100 in the direction of travel 110 of the magnetic tape. The surface contact area between data island 100 and the magnetic tape can be reduced, as compared to the surface contact area between a magnetic tape and a data island that does not include slots located between read/write elements. In this manner, this technique can reduce the surface contact area between data island 100 and the magnetic tape and can reduce friction and drag between the read/write head and the magnetic tape, which can improve system performance.

In another example, edges 112a and 112b of data island 100 can have or be formed with sharp edges or substantially 90 degree corners at or near read/write elements 102a-102d, i.e., the edges of data island 100 are sharp or substantially 90 degree corners in front of and behind each of the read/write elements 102a-102d in the direction of travel 110 of the magnetic tape. These sharp edges skive off air under the tape to create a negative pressure area between the magnetic tape and each of the read/write elements 102a-102d. The terms “skive”, “skive off” and “skiving” refer to the notion of removing or scraping or diverting away air or air flow from an area of the magnetic tape. For example, in order to move or place the magnetic tape in contact with the read/write head, an air boundary layer may need to be removed from an area of the magnetic tape. The air or air flow may tend to cling to the moving surface of the magnetic tape due to its viscosity. If this air or air flow is not removed from the magnetic tape surface, the air may be pulled into the interface which may cause the magnetic tape to float above the read/write head. In another example, read/write head may be configured to have rails with a controlled edge so that the magnetic tape may be advanced across a precise overwrap angle, which may be referred to as a process of air skiving.

In one example, these negative pressure areas help guide or attract the magnetic tape closer to the read/write elements 102a-102d, which can increase the read/write signal to noise ratio and the data storage density on the magnetic tape. It should be understood that this example is for illustrative purposes and that other examples are possible. For example, although 4 read/write elements are shown, a different number of read/write elements and arrangements could be employed to implement the techniques of the present application.

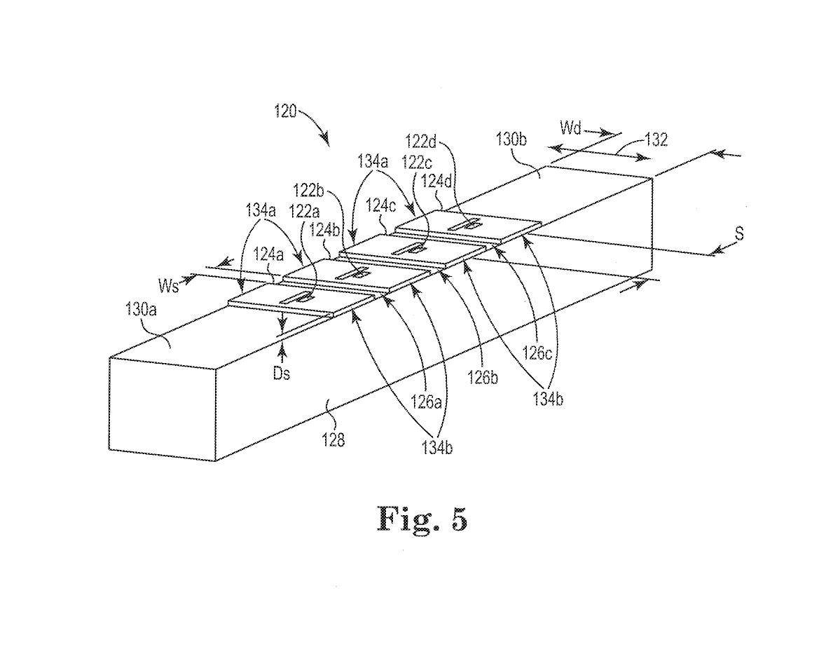

FIG. 5 is a diagram illustrating one example of a data island 120 that includes four read/write elements 122a-122d coated or formed with coating material 124a-124d to provide slots 126a-126c. The coating material 124a-124d can include one or more substances that are different in composition and structure from the material used to construct data island 120. These coating materials can be applied using different techniques. In one example, the coating materials can be applied in a sputtered application of one or more layers to form the coating material 124a-124d. In one example, the coating materials can be applied by Atomic Layer Deposition of one or more layers. In one example, the coating materials can be applied by a plated application of one or more layers. In other examples, the coating materials can be applied using different suitable techniques. In one example, each of the read/write elements 122a-122d can include an MR type element, such as an AMR element, a TMR element, a GMR element, a CPPGMR element, and/or a CMR element. In one example, data island 120 can be similar to one of the data islands 62 and 64 of FIG. 3.

In one example, data island 120 includes read/write elements 122a-122d, coating material 124a-124d, slots 126a-126c, and data island substrate material 128. The slot 126a is located between coating material 124a on read/write element 122a and coating material 124b on read/write element 122b. The slot 126b is located between coating material 124b on read/write element 122b and coating material 124c on read/write element 122c. The slot 126c is located between coating material 124c on read/write element 122c and coating material 124d on read/write element 122d. In one example, data island substrate material 128 includes substrate end pieces 130a and 130b, which may not be coated or formed with coating material 124. The gaps located between coating material 124a-124d form or provide slots 126a-126c. In one example, substrate end pieces 130a and 130b are removed, such that data island 120 includes coating material 124a-124d on read/write elements 122a-122d and slots 126a-126c between read/write elements 122a-122d.

The data island 120 has a data island width Wd and read/write elements 122a-122d are separated a centerline spacing distance S from the centerline of one of the read/write elements 122a-122d to the center line of an adjacent one of the read/write elements 122a-122d. Each of the slots 126a-126e has a slot width Ws and a slot depth Ds. In one example, the data island width Wd can be on the order of 300 to 600 um. In one example, the centerline spacing S of the read/write elements 122a-122d is on the order of 41 to 166 um. In one example, the slot depth Ds is on the order of 10 to 100 nanometers (nm). In one example, the slot width Ws is on the order of 5 to 75 um.

In one example, to manufacture or fabricate data island 120, read/write elements 122a-122d are formed in data island substrate material 128. In one step of the process, coating material 124 is applied over data island substrate material 128 and read/write elements 122a-122d. In a next step, coating material 124 is removed from substrate end pieces 130a and 130b and from between read/write elements 122a-122d to form coating material pieces 124a-124d, which in turn forms slots 126a-126c between coating material 124a-124d on read/write elements 122a-122d. In one example, coating material 124 can be removed by etching coating material 124. In one example, coating material 124 can be diamond-like-carbon. In one example, coating material 124 can be titanium. In one example, coating material 124 can be zirconium nitride. In one example, coating material 124 can be silicon carbide. In one example, coating material 124 can be silicon nitride. In one example, coating material 124 can be another suitable wear-resistant material. In one example, coating material 124 is a multi-layer coating material. In one example, the coating material 124 can be selected to reduce friction and drag to the magnetic tape through either the appropriate material choices or the coating structure or both.

In one example, in operation, a magnetic tape is guided or advanced across data island 120 in the direction of travel 132 of the magnetic tape. The slots 126a-126c route or channel air under the magnetic tape from between the coating material 124a-124d and the magnetic tape, such that the magnetic tape can ride or pass closer to read/write elements 122a-122d. In this manner, this technique can increase the read/write signal to noise ratio and data storage density on the magnetic tape. Also, the surface contact area between data island 120 and the magnetic tape can be reduced, as compared to the surface contact area between a magnetic tape and a data island that does not include coating material on read/write elements and slots between read/write elements. In this manner, reducing the surface contact area between data island 120 and the magnetic tape can reduce friction and drag between the read/write head and the magnetic tape, which in turn can improve system performance.

In one example, edges 134a and 134b of coating material 124a-124d can be formed as sharp edges or substantially 90 degree corners at read/write elements 122a-122d, i.e., the edges of coating material 124a-124d are sharp or substantially 90 degree corners in front of and behind each of the read/write elements 122a-122d in the direction of travel 132 of the magnetic tape. In one example, these sharp edges skive off air under the tape to generate or create a negative pressure area between the magnetic tape and each of the coating material 124a-124d on read/write elements 122a-122d. The negative pressure areas can attract or pull the magnetic tape closer to read/write elements 122a-122d, which can increase the read/write signal to noise ratio and the data storage density on the magnetic tape.

It should be understood that this example is for illustrative purposes and that other examples are possible. For example, although 4 read/write elements are shown, a different number of read/write elements and arrangements could be employed to implement the techniques of the present application.

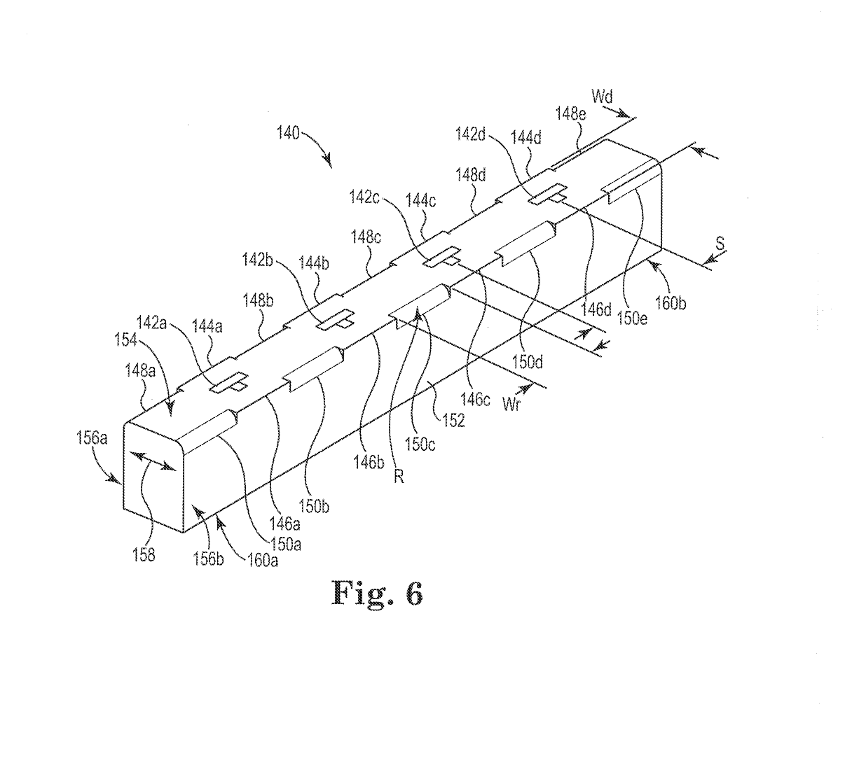

FIG. 6 is a diagram illustrating one example of a data island 140 that includes four read/write elements 142a-142d and sharp edges 144a-144d and 146a-146d at read/write elements 142a-142d and rounded edges 148a-148e and 150a-150e on each side of and between read/write elements 142a-142d. In one example, each of the read/write elements 142a-142d can include an MR type element, such as an AMR element, a TMR element, a GMR element, a CPPGMR element, and/or a CMR element. In one example, data island 140 can be similar to one of the data islands 62 and 64 (shown in FIG. 3).

In one example, data island 140 includes read/write elements 142a-142d and data island substrate material 152 that has a top surface 154 and sides 156a and 156b. The magnetic tape contacts top surface 154 and moves with respect to that surface in the direction of travel 158 of the magnetic tape. The data island substrate material 152 has or is formed with sharp edges 144a-144d and 146a-146d at the junction of top surface 154 and sides 156a and 156b in front of and behind each of the read/write elements 142a-142d in the direction of travel 158 of a magnetic tape. These sharp edges 144a-144d and 146a-146d are formed as substantially 90 degree corners at read/write elements 142a-142d. The data island substrate material 152 has rounded edges 148a-148e and 150a-150e at the junction of top surface 154 and sides 156a and 156b on each side of and between read/write elements 142a-142d. In one example, rounded edges 148a-148e and 150a-150e are formed as a curved contour in a radius on each side of and between read/write elements 142a-142d.

In one example, rounded edges 148a-148e and 150a-150e do not skive off the laminar flow of air that is under the magnetic tape as the magnetic tape passes over data island 140. Instead, rounded edges 148a-148e and 150a-150e pressurize the air that clings to the tape surface, enabling an air bearing to form between the magnetic tape and the data island substrate material 152. The magnetic tape flies or passes over data island 140 at rounded edges 148a-148e and 150a-150e. In one example, the thickness of air over the data island surface in between the active read/write elements created by the rounded edges 148a-148e and 150a-150e is 100 to 1000 nm thick.

In one example, sharp edges 144a-144d and 146a-146d skive off the laminar flow of air under the magnetic tape to create a negative pressure area between the magnetic tape and each of the read/write elements 142a-142d. The atmospheric pressure pushes the magnetic tape into contact with read/write elements 142a-142d, since the negative pressure areas cannot support the magnetic tape. This can increase the read/write signal to noise ratio and the data storage density on the magnetic tape. In one example, substrate end pieces 160a and 160b can be removed, such that data island 140 includes read/write elements 142a-142d and has sharp edges 144a-144d and 146a-146d at read/write elements 142a-142d and rounded edges 148b-148d and 150b-150d between read/write elements 142a-142d.

The data island 140 has a data island width Wd and read/write elements 142a-142d are separated a centerline spacing distance S from the centerline of one of the read/write elements 142a-142d to the center line of an adjacent one of the read/write elements 142a-142d. Each of the the rounded edges 148a-148e and 150a-150e has a radius of curvature R and a rounded edge width Wr. In one example, the data island width Wd can be on the order of 300 to 600 um. In one example, the centerline spacing S of the read/write elements 142a-142d is on the order of 41 to 166 um. In one example, the radius of curvature R is on the order of 0.1 to 3.0 mm. In one example, the rounded edge width Wr is on the order of 5 to 75 um.

In one example, to manufacture or fabricate data island 140, read write elements 142a-142d are formed in data island substrate material 152. In a next step of the process, rounded edges 148a-148e and 150a-150e are formed at the junction of top surface 154 and sides 156a and 156b in data island substrate material 152 on each side of the read/write elements 142a-142d and between read/write elements 142a-142d. The sharp edges 144a-144d and 146a-146d are formed or provided in front of and behind each of the read/write elements 142a-142d in the direction of travel 158 of the magnetic tape. In one example, rounded edges 148a-148e and 150a-150e are formed or etched into data island substrate material 152. In one example, rounded edges 148a-148e and 150a-150e are formed or mechanically machined into data island substrate material 152.

In one example, in operation, a magnetic tape is guided or advanced across the top surface 154 of data island 140 in the direction of travel 158 of the magnetic tape. The rounded edges 148a-148e and 150a-150e do not skive off air under the magnetic tape, such that air clings to the magnetic tape surface at rounded edges 148a-148e and 150a-150e. The sharp edges 144a-144d and 146a-146d skive off air under the magnetic tape to create a negative pressure area between the magnetic tape and each of the read/write elements 142a-142d. The atmospheric pressure pushes the magnetic tape into contact with the read/write elements 142a-142d as the negative pressure areas cannot support the magnetic tape. This can increase the read/write signal to noise ratio and the data storage density on the magnetic tape. Also, the surface contact area between data island 140 and the magnetic tape can be reduced, as compared to the surface contact area between a magnetic tape and a data island that does not have rounded edges 148a-148e and 150a-150e. In this manner, reducing the surface contact area between data island 140 and the magnetic tape can reduce friction and drag between the read/write head and the magnetic tape, which can improve system performance.

It should be understood that this example is for illustrative purposes and that other examples are possible. For example, although 4 read/write elements are shown, a different number of read/write elements and arrangements could be employed to implement the techniques of the present application.

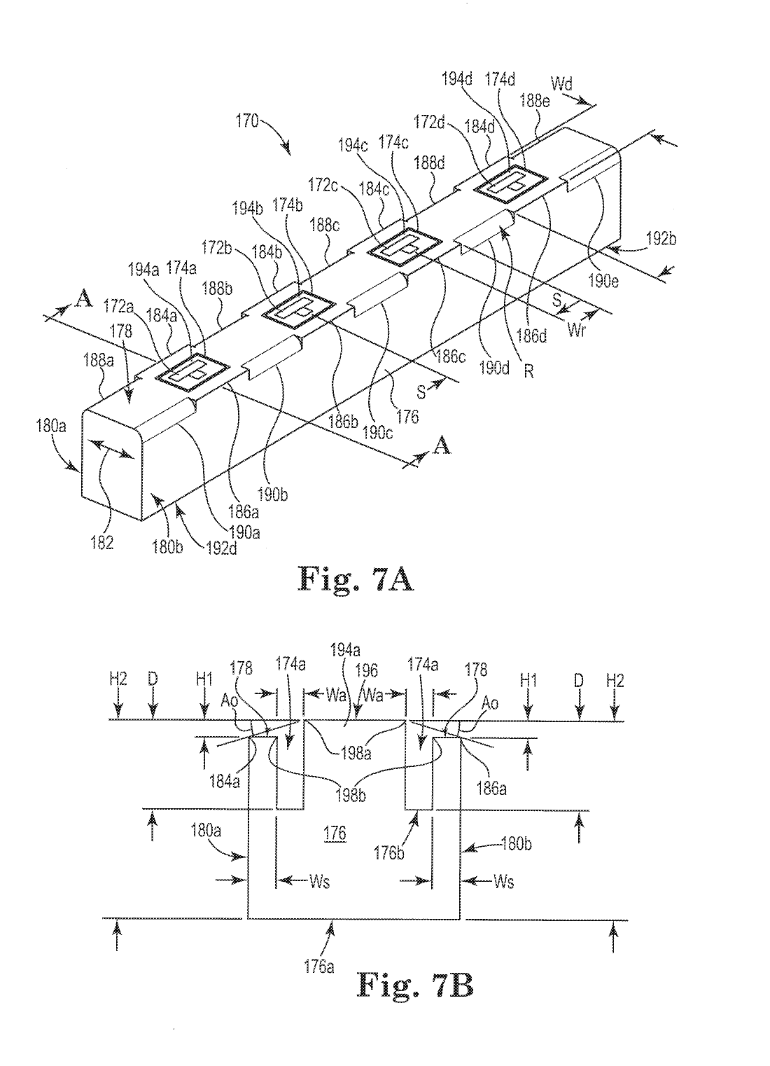

FIG. 7A is a diagram illustrating one example of a data island 170 that includes four read/write elements 172a-172d and platform slots 174a-174d. In one example, each of the read/write elements 172a-172d can include an MR type element, such as an AMR element, a TMR element, a GMR element, a CPPGMR element, and/or a CMR element. In one example, data island 170 can be similar to one of the data islands 62 and 64 (shown in FIG. 3).

In one example, data island 170 includes read/write elements 172a-172d and data island substrate material 176, which has a top surface 178 and sides 180a and 180b. The magnetic tape moves with respect to top surface 178 in the direction of travel 182 of the magnetic tape. Each of the read/write elements 172a-172d is formed in a corresponding read/write platform 194a-194d in data island substrate material 176. A top surface 196 (shown in FIG. 7B) of each of the read/write platforms 194a-194d is above or higher than top surface 178. The slots 174a-174d include slots cut into or formed in data island substrate material 176 around each of the read/write platforms 194a-194d.

In one example, the top surfaces 196 of read/write platforms 194a-194d are raised a height H1 with respect to top surface 178. In one direction, the magnetic tape initially contacts top surface 178 at edges 184a-184d. In the other direction, the magnetic tape initially contacts top surface 178 at edges 186a-186d. An overwrap angle Ao results from the magnetic tape rising from top surface 178 to top surface 196. By means of slots 174a-174d, a skiving edge is created ahead of each of the read/write platforms 194a-194d, which combined with the overwrap angle Ao, skives the air from the magnetic tape surface and puts the magnetic tape into contact with the read/write head due to atmospheric pressure on the magnetic tape backside. In one example, the slots 174a-174d reduce the area of the magnetic tape surface in contact with data island 170 and provide a way to set the overwrap angle Ao of the magnetic tape relative to edge 184a and edge 186a and top surface 196. Without slots 174a-174d, the magnetic tape can cling to substrate material 176 after the initial contact at edge 184a or 186a, leading to increased friction. In one example, each of the read/write platforms 194a-194d can be formed as a parallelogram and each of the slots 174a-174d can be formed as a parallelogram shaped slot around four sides of the corresponding read/write plafform 194a-194d. In other examples, each of the read/write platforms 194a-194d can be formed in any suitable shape and each of the slots 174a-174d can be formed in any suitable shape that sets a suitable overwrap angle Ao.

In one example, data island substrate material 176 can include or be formed with sharp edges 184a-184d at the junction of top surface 196 and side 180a and with sharp edges 186a-186d at the junction of top surface 178 and side 180b, in front of and behind each of the read/write elements 172a-172d in the direction of travel 182 of the magnetic tape. These sharp edges 184a-184d and 186a-186d can have or be formed with substantially 90 degree corners at read/write elements 172a-172d. The data island substrate material 176 can have or be formed with rounded edges 188a-188e and 190a-190e at the junction of top surface 178 and sides 180a and 180b on each side of and between each of the read/write platforms 194a-194d. In one example, rounded edges 188a-188e and 190a-190e are formed with a curved contour in a radius on each side of and between each of the read/write platforms 194a-194d in the direction of travel 182 of the magnetic tape.

In one example, rounded edges 188a-188e and 190a-190e do not skive off the laminar flow of air that is under the magnetic tape as the magnetic tape passes over data island 170. Instead, for tape motion from left to right, rounded edges 188a-188e pressurize the air that clings to the tape surface only in the region of the rounded edges 188a-188e, creating a localized air film that floats that area of the magnetic tape over the read/write element. Also, for tape motion from right to left, rounded edges 190a-190e pressurize the air that clings to the tape surface only in the region of the rounded edges 190a-190e, creating a localized air film that floats that area of the magnetic tape over the read/write element. In one example, the thickness of air over the data island surface in between the active read/write elements created by the rounded edges 188a-188e and 190a-190e is 100 to 1000 nm.

In one example, sharp edges 184a-184d and 186a-186d skive off the laminar flow of air under the magnetic tape to create a negative pressure area between the magnetic tape and each of the read/write elements 172a-172d. The atmospheric pressure pushes the magnetic tape into contact with read/write elements 172a-172d, since the negative pressure areas cannot support the magnetic tape. This can increase the read/write signal to noise ratio and the data storage density on the magnetic tape. In one example, substrate end pieces 192a and 192b are removed, such that data island 170 includes read/write platforms 194a-194d with read/write elements 172a-172d and slots 174a-174d and has sharp edges 184a-184d and 186a-186d at read/write platforms 194a-194d and rounded edges 188b-188d and 190b-190d between each of the read/write platforms 194a-194d.

The data island 170 has a data island width Wd and read/write elements 172a-172d are separated a centerline spacing distance S from the centerline of one of the read/write elements 172a-172d to the center line of an adjacent one of the read/write elements 172a-172d. Each of the rounded edges 188a-188e and 190a-190e has a radius of curvature R and a rounded edge width Wr. In one example, the data island width Wd can be on the order of 300 to 600 um. In one example, the centerline spacing S of the read/write elements 172a-172d is on the order of 41 to 166 um. In one example, the radius of curvature R is on the order of 0.1 to 3.0 mm. In one example, the rounded edge width Wr is on the order of 5 to 75 um.

In one example, to manufacture or fabricate data island 170, in one step of the process, read/write elements 172a-172d are formed in data island substrate material 176. In a next step of the process, data island substrate material 176 is cut down or formed, such as by etching, to produce each of the read/write platforms 194a-194d. In a next step of the process, slots 174a-174d are cut into or formed in data island substrate material 176. In an alternative example, slots 174a-174d are cut into or formed in data island substrate material 176 and then data island substrate material 176 is cut down or formed, such as by etching, to produce each of the read/write platforms 194a-194d.

In a next step of the process, rounded edges 188a-188e and 190a-190e are cut into or formed at the junction of top surface 178 and sides 180a and 180b in data island substrate material 176 on each side of the read/write platforms 194a-194d and between read/write platforms 194a-194d. In one example, sharp edges 184a-184d and 186a-186d are formed or provided in front of and behind each of the read/write elements 172a-172d in the direction of travel 182 of the magnetic tape. In one example, slots 174a-174d and/or rounded edges 188a-188e and 190a-190e are etched into data island substrate material 176. In one example, slots 174a-174d and/or rounded edges 188a-188e and 190a-190e are mechanically machined into data island substrate material 176.

In one example, in operation, a magnetic tape is guided or advanced across data island 170 in the direction of travel 182 of the magnetic tape. The rounded edges 188a-188e and 190a-190e do not skive off air under the magnetic tape, such that air clings to the magnetic tape surface at rounded edges 188a-188e and 190a-190e. The sharp edges 184a-184d and 186a-186d skive off air under the magnetic tape to generate or create a negative pressure area between the magnetic tape and each of the read/write elements 172a-172d as the magnetic tape passes over data island 170 in the direction of travel 182 of the magnetic tape. The atmospheric pressure pushes the magnetic tape into contact with the read/write elements 172a-172d as the negative pressure areas cannot support the magnetic tape. This can increase the read/write signal to noise ratio and the data storage density on the magnetic tape. Also, the surface contact area between data island 170 and the magnetic tape can be reduced, as compared to the surface contact area between a magnetic tape and a data island that does not have slots 174a-174d and rounded edges 188a-188e and 190a-190e. In this manner, reducing the surface contact area between data island 170 and the magnetic tape can reduce friction and drag between the read/write head and the magnetic tape, which can improve system performance.

It should be understood that this example is for illustrative purposes and that other examples are possible. For example, although 4 read/write elements are shown, a different number of read/write elements and arrangements could be employed to implement the techniques of the present application.

FIG. 7B is a diagram illustrating one example of a cross section of data island 170 taken along the line A-A in FIG. 7A. Data island substrate material 176 has a bottom surface 176a, top surface 178, and sides 180a and 180b. Read/write platform 194a has top surface 196, which is above or higher than top surface 178 a height H1. Data island substrate material 176 has a height H2 from bottom surface 176a to top surface 196.

Slot 174a includes a slot cut into or formed in data island substrate material 176 around read/write platform 194a and has a bottom surface 176b. Slot 174a has a width Wa from one side of slot 174a to the other side of slot 174a and a depth D from top surface 196 to bottom surface 176b. The substrate 176 has a substrate width Ws from one side of slot 174a to side 180a and from one side of slot 174a to side 180b. In one example, slot width Wa, substrate width Ws, and height H1 are dimensioned to provide an overwrap angle Ao, which is the angle of incidence of the magnetic tape relative to top surface 196 and each of the edges 184a and 186a, on the order of 0.35 degrees to 1.25 degrees. In one example, slot depth D can be on the order of 25 um.

In one example, slot 174a can include or be formed with sharp edge 198a at the junction of top surface 196 and slot 174a and with sharp edge 198b at the junction of top surface 178 and slot 174a. These sharp edges 198a and 198b can have or be formed with substantially 90 degree corners.

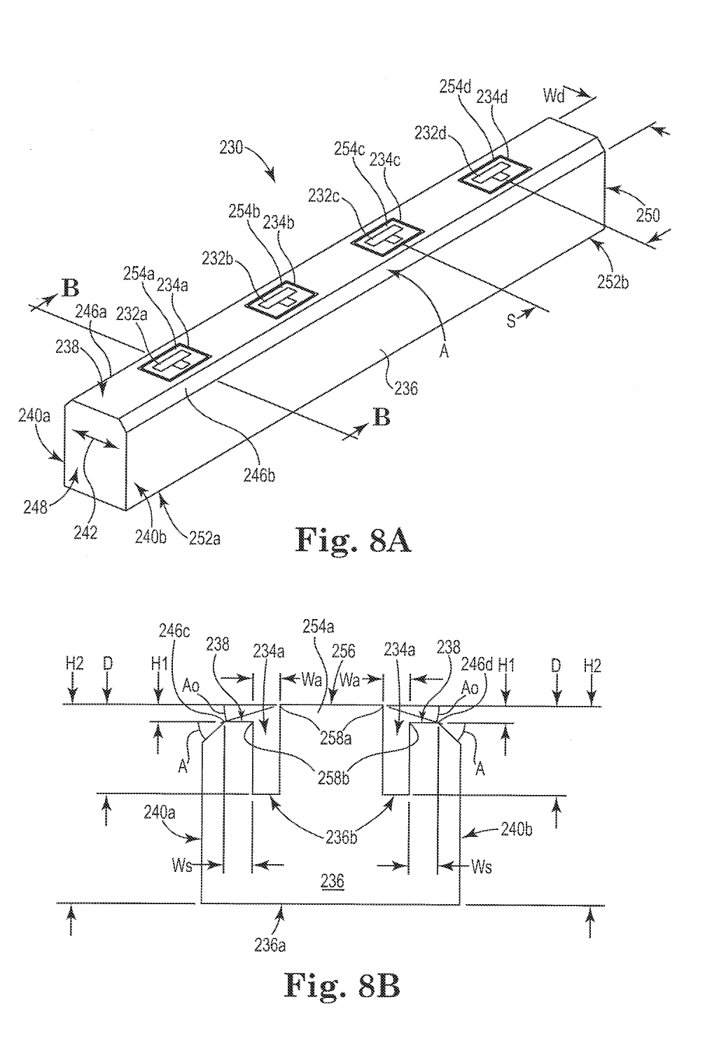

FIG. 8A is a diagram illustrating one example of a data island 230 that has chamfered edges 246a and 246b and includes read/write elements 232a-232d and platform slots 234a-234d. In one example, each of the read/write elements 232a-232d can include an MR type element, such as an AMR element, a TMR element, a GMR element, a CPPGMR element, and/or a CMR element. In one example, data island 230 can be similar to one of the data islands 62 and 64 (shown in FIG. 3). In one example, the edges at 246a and 246b can be rounded edges and not chamfered.

In one example, data island 230 includes read/write elements 232a-232d, slots 234a-234d, and data island substrate material 236, which has a top surface 238 and sides 240a and 240b. Each of the read/write elements 232a-232d is formed in a corresponding read/write platform 254a-254d in data island substrate material 236. A top surface 256 (shown in FIG. 8B) of each of the read/write platforms 254a-254d is above or higher than top surface 238. In one example, slots 234a-234d are slots that can be cut into or formed in data island substrate material 236 around each of the read/write platforms 254a-254d. In one example, the top surfaces 256 of read/write platforms 254a-254d are raised a height H1 with respect to top surface 238. In one direction, the magnetic tape initially contacts the chamfered edge 246a that has an angle A. In the other direction, the magnetic tape initially contacts the chamfered edge 246b that has angle A. An overwrap angle Ao results from the magnetic tape rising from top surface 238 to top surface 256. By means of slots 234a-234d, a skiving edge is created ahead of each of the read/write platforms 254a-254d, which combined with the overwrap angle Ao, skives the air from the magnetic tape surface and puts the magnetic tape into contact with the read/write head due to atmospheric pressure on the magnetic tape backside. In one example, the slots 234a-234d reduce the area of the magnetic tape surface in contact with data island 230 and provide a way to set the overwrap angle Ao of the magnetic tape relative to chamfered edge 246a and chamfered edge 246b and top surface 256. Without slots 234a-234d, the magnetic tape can cling to substrate material 236 after the initial contact at chamfered edges 246a and 246b, leading to increased friction. In one example, each of the read/write platforms 254a-254d can be formed as a parallelogram and each of the slots 234a-234d can be formed as a parallelogram shaped slot around four sides of the corresponding read/write platform 254a-254d. In other examples, each of the read/write platforms 254a-254d can be formed in any suitable shape and each of the slots 234a-234d can be formed in any suitable shape that sets a suitable overwrap angle Ao.

In one example, data island substrate material 236 can be formed with chamfered edges 246a and 246b at the junction of top surface 238 and sides 240a and 240b. The chamfered edges 246a and 246b can be formed or located in front of, behind, on each side of, and between read/write platforms 254a-254d and read/write elements 232a-232d.

In one example, chamfered edges 246a and 246b on each side of and between read/write platforms 254a-254d and read/write elements 232a-232d do not skive off the laminar flow of air that is under the magnetic tape as the magnetic tape passes over data island 230. Instead, for tape motion from left to right, chamfered edge 246a on each side of and between read/write platforms 254a-254d and read/write elements 232a-232d pressurizes the air that clings to the tape surface in this region, creating a localized air film that floats that area of the magnetic tape over the read/write element. Also, for tape motion from right to left, chamfered edge 246b on each side of and between read/write platforms 254a-254d and read/write elements 232a-232d pressurizes the air that clings to the tape surface in this region, creating a localized air film that floats that area of the magnetic tape over the read/write element. In one example, the thickness of air over the data island surface created by the chamfered edges 246a and 246b is 100 to 1000 nm.

The data island 230 has a data island width Wd and read/write elements 232a-232d are separated a centerline spacing distance S from the centerline of one of the read/write elements 232a-232d to the center line of an adjacent one of the read/write elements 232a-232d. Each of the chamfered edges 246a and 246b is manufactured at an angle A (shown in FIG. 813) as measured from top surface 238. In one example, chamfered edges 246a and 246b are manufactured at different angles. In one example, the data island width Wd can be on the order of 300 to 600 um. In one example, the centerline spacing S of the read/write elements 232a-232d can be on the order of 41 to 166 um. In one example, the angle A of one or more of the chamfered edges 246a and 246b can be on the order of 0.25 degrees to 2.5 degrees.

In one example, to manufacture or fabricate data island 230, read/write elements 232a-232d can be formed in data island substrate material 236. In a next step of the process, data island substrate material 236 is cut down or formed, such as by etching, to produce each of the read/write platforms 254a-254d. In a next step of the process, slots 234a-234d can be cut into or formed in data island substrate material 236. In an alternative example, slots 234a-234d are cut into or formed in data island substrate material 236 and then data island substrate material 236 is cut down or formed, such as by etching, to produce each of the read/write platforms 254a-254d.

In a next step of the process, chamfered edges 246a and 246b are cut into or formed at the junction of top surface 238 and sides 240a and 240b in data island substrate material 236. In one example, slots 234a-234d and/or chamfered edges 246a and 246b can be formed or etched through an etching process into data island substrate material 236. In one example, slots 234a-234d and/or chamfered edges 246a and 246b can be formed through a mechanical process of mechanically machining them into data island substrate material 236.

In one example, in operation, a magnetic tape can be guided or advanced across data island 230 in the direction of travel 242 of the magnetic tape. The chamfered edges 246a and 246b on each side of and between read/write platforms 254a-254d and read/write elements 232a-232d do not skive off air under the magnetic tape, such that air clings to the magnetic tape surface at chamfered edges 246a and 246b on each side of and between read/write platforms 254a-254d and read/write elements 232a-232d. By means of slots 234a-234d and chamfered edges 246a and 246b, a skiving edge is created ahead of each of the read/write platforms 254a-254d, which combined with the overwrap angle Ao, skives the air from the magnetic tape surface and puts the magnetic tape into contact with the read/write head due to atmospheric pressure on the magnetic tape backside. This technique can attract or pull the magnetic tape closer to read/write elements 232a-232d, which can increase the read/write signal to noise ratio and the data storage density on the magnetic tape. Also, the surface contact area between data island 230 and the magnetic tape can be reduced, as compared to the surface contact area between a magnetic tape and a data island that does not have slots 234a-234d. In one example, reducing the surface contact area between data island 230 and the magnetic tape can reduce friction and drag between the read/write head and the magnetic tape, which can improve system performance.

It should be understood that this example is for illustrative purposes and that other examples are possible. For example, although 4 read/write elements are shown, a different number of read/write elements and arrangements could be employed to implement the techniques of the present application.

FIG. 8B is a diagram illustrating one example of a cross section of data island 230 taken along the line B-B in FIG. 8A. Data island substrate material 236 has a bottom surface 236a, top surface 238, and sides 240a and 240b. Read/write platform 254a has top surface 256, which is above or higher than top surface 238 a height H1. Data island substrate material 236 has a height H2 from bottom surface 236a to top surface 256.

Slot 234a includes a slot cut into or formed in data island substrate material 236 around read/write platform 254a and has a bottom surface 236b. Slot 234a has a width Wa from one side of slot 234a to the other side of slot 234a and a depth D from top surface 256 to bottom surface 236b. The substrate 236 has a substrate width Ws from one side of slot 234a to an edge 246c of chamfered edge 246a and from one side of slot 234a to an edge 246d of chamfered edge 246b. In one example, slot width Wa, substrate width Ws, and height H1 are dimensioned to provide an overwrap angle Ao, which is the angle of incidence of the magnetic tape relative to top surface 256 and edges 246c and 246d, on the order of 0.35 degrees to 1.25 degrees. In one example, slot depth D can be on the order of 25 um.

In one example, slot 234a can include or be formed with sharp edge 258a at the junction of top surface 256 and slot 234a and with sharp edge 258b at the junction of top surface 238 and slot 234a. These sharp edges 258a and 258b can have or be formed with substantially 90 degree corners.

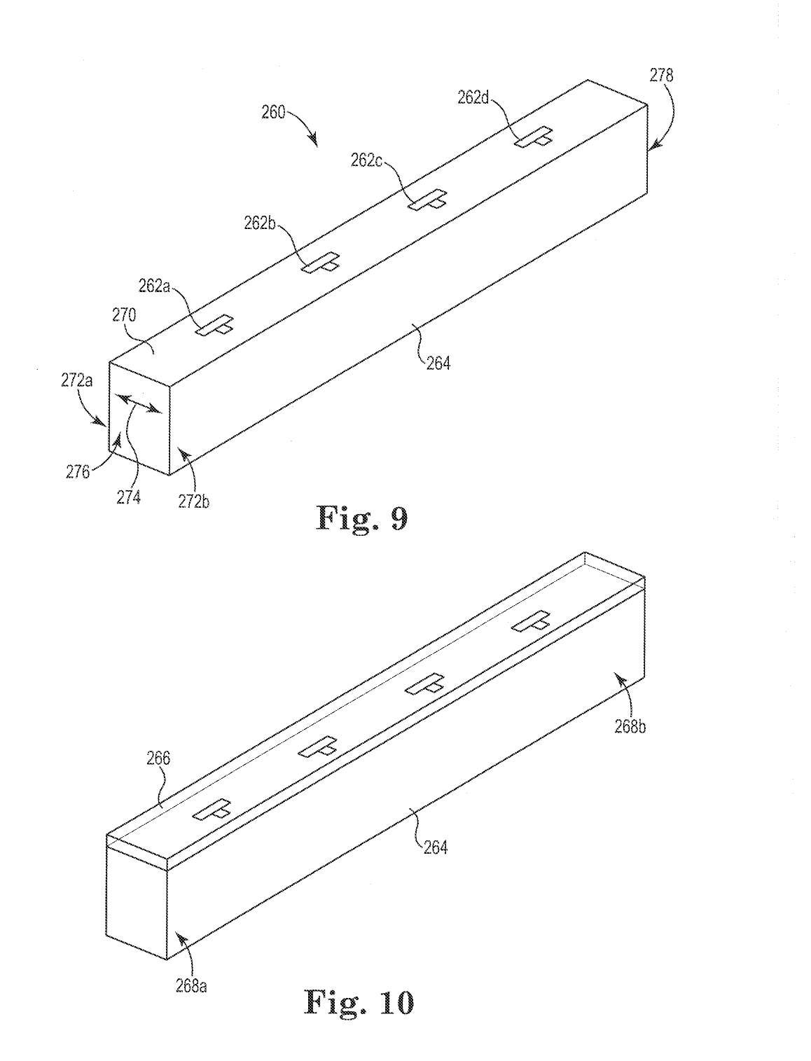

FIG. 9 is a diagram illustrating one example of a data island 260 that includes four read/write elements 262a-262d and data island substrate material 264. The data island 260 can be manufactured or fabricated into any of the data islands such as data island 100 of FIG. 4, data island 120 of FIG. 5, data island 140 of FIG. 6, data island 170 of FIG. 7A, and data island 230 of FIG. 8A.

In one example, to manufacture or fabricate a data island such as data island 100 of FIG. 4, slots, such as slots 106a-106e, can be formed through a process to cut into data island substrate material 264 to remove material. In one example, the resulting data island is the same as data island 100 of FIG. 4. In one example, slots can be etched through an etching process into data island substrate material 264. In one example, slots can be formed by mechanically machining them into data island substrate material 264.

In one example, to manufacture or fabricate a data island such as data island 120 of FIG. 5, a process can be performed including application of coating material 266 over data island substrate material 264 and read/write elements 262a-262d. FIG. 10 is a diagram illustrating one example of coating material 266 applied over data island substrate material 264 and read/write elements 262a-262d. In a next step of the process, coating material 266 can be removed from substrate end pieces 268a and 268b and from between read/write elements 262a-262d to form coating material pieces, such as coating material pieces 124a-124d, which in turn form slots, such as slots 126a-126c. In one example, the resulting data island can be similar to data island 120 of FIG. 5. In one example, coating material 266 can be removed by etching coating material 266. In one example, coating material 266 can be diamond-like-carbon. In one example, coating material 266 can be titanium. In one example, coating material 266 can be zirconium nitride. In one example, coating material 266 can be silicon carbide. In one example, coating material 266 can be silicon nitride. In one example, coating material 266 can be another suitable wear-resistant material.

In one example, to manufacture or fabricate a data island such as data island 140 of FIG. 6, a process is performed to form rounded edges, such as rounded edges 148a-148e and 150a-150e, at the junction of top surface 270 and sides 272a and 272b in data island substrate material 264 on each side of the read/write elements 262a-262d and between read/write elements 262a-262d. The sharp edges are formed or provided in front of and behind each of the read/write elements 262a-262d in the direction of travel 274 of the magnetic tape. In one example, the resulting data island can be similar to data island 140 of FIG. 6. In one example, rounded edges can be etched through an etching process into data island substrate material 264. In one example, rounded edges are formed by mechanically machining data island substrate material 264.

In one example, to manufacture or fabricate a data island such as data island 170 of FIG. 7A, data island substrate material 264 is cut down or formed, such as by etching, to produce read/write platforms having top surface 270, such as read/write platforms 194a-194d. In another step of the process, slots, such as slots 174a-174d, are cut into or formed in data island substrate material 264 around the read/write platforms and rounded edges, such as rounded edges 188a-188e and 190a-190e, are cut into or formed at the junction of the top surface of the cut down data island substrate 264 and sides 272a and 272b in data island substrate material 264 on each side of the read/write elements 262a-262d and between read/write elements 262a-262d. The sharp edges, such as sharp edges 184a-184d and 186a-186d, can be formed or provided in front of and behind each of the read/write elements 262a-262d in the direction of travel 274 of the magnetic tape. In one example, the resulting data island can be similar to data island 170 of FIG. 7A. In one example, slots and/or rounded edges can be formed or etched through an etching process into data island substrate material 264. In one example, slots and/or rounded edges can be formed by mechanically machining them into data island substrate material 264.

In one example, to manufacture or fabricate a data island such as data island 230 of FIG. 8A, data island substrate material 264 is cut down or formed, such as by etching, to produce read/write platforms having top surface 270, such as read/write platforms 254a-254d. In another step of the process, slots, such as slots 234a-234d, are cut into or formed in data island substrate material 264 and chamfered edges, such as chamfered edges 246a and 246b, are cut into or formed in data island substrate material 264. In one example, chamfered edges can be provided at the junction of the top surface of the cut down data island substrate 264 and sides 272a and 272b. In one example, the resulting data island can be similar to data island 230 of FIG. 8A. In one example, slots and/or chamfered edges can be etched in an etching process into data island substrate material 264. In one example, slots and/or chamfered edges can be formed by mechanically machining them into data island substrate material 264.

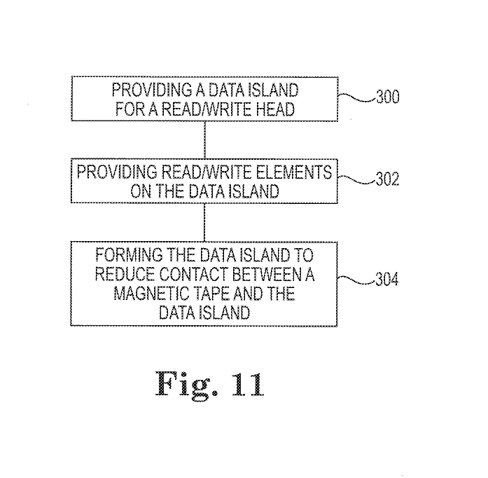

FIG. 11 is a flow-chart diagram illustrating one example of a process for manufacturing a data island. The first step in the process at block 300 includes providing a data island for a read/write head that writes to a magnetic tape. The next step in the process at block 302 includes providing read/write elements on the data island. The next step in the process at block 304 includes forming the data island to reduce contact between the magnetic tape and the data island at locations between the read/write elements. The data island can be formed as described above to provide any of the example data islands described above.

In one example, the process can be used to manufacture the data island 28 (shown in FIG. 1). In one example, the process can be used to manufacture the data islands 48 (shown in FIG. 2). In one example, the process can be used to manufacture the data islands 62 and 64 (shown in FIG. 3). In one example, the process can be used to manufacture the data island 100 of FIG. 4. In one example, the process can be used to manufacture the data island 120 of FIG. 5. In one example, the process can be used to manufacture the data island 140 of FIG. 6. In one example, the process can be used to manufacture the data island 170 of FIG. 7A. In one example, the process can be used to manufacture the data island 230 of FIG. 8A. In other examples, the process can be used to manufacture other suitable data islands.

The techniques of the present application can provide advantages. For example, the data islands described above can reduce friction and drag between a read/write head and a magnetic tape. In this manner, reduced coupling between the read/write head and the magnetic tape can enable enhanced servo tracking performance, especially as the magnetic tape surface roughness changes over the life of the magnetic tape. Furthermore, this can improve performance, which can help provide higher data storage densities.

Although specific embodiments have been illustrated and described herein, it will be appreciated that a variety of alternate and/or equivalent implementations may be substituted for the specific embodiments shown and described without departing from the scope of the techniques of the present application. This application is intended to cover any adaptations or variations of the specific embodiments discussed herein.

1. A system comprising:
a read/write head to write to a magnetic tape, the read/write head including:
a data island that includes read/write elements, the data island to reduce contact between the magnetic tape and the data island at locations between the read/write elements.

2. The system of claim 1, further comprising:
slots between the read/write elements.

3. The system of claim 2, wherein material is absent from between the read/write elements to provide the slots between the read/write elements.

4. The system of claim 2, wherein the read/write elements are coated with material and area between the read/write elements is absent of the material to provide the slots between the read/write elements.

5. The system of claim 1, further comprising at least one of:
rounded edges on the data island between the read/write elements and sharp edges on the data island at the read/write elements; and
chamfered edges on the data island between the read/write elements and sharp edges on the data island at the read/write elements.

6. The system of claim 1, further comprising:
slots between and adjacent the read/write elements.

7. The system of claim 6, further comprising at least one of:
rounded edges on the data island between the read/write elements and sharp edges on the data island at the read/write elements; and
chamfered edges on the data island between the read/write elements and sharp edges on the data island at the read/write elements.

8. A system comprising:
a read/write head to write to a magnetic tape, the read/write head including:
a data island that includes read/write elements and sharp edges at the read/write elements, wherein the data island to reduce friction between the data island and the magnetic tape at locations between the read/write elements on the data island.

9. The system of claim 8, further comprising:
rounded edges on the data island between the read/write elements on the data island.

10. The system of claim 8, further comprising:
slots between the read/write elements on the data island.

11. The system of claim 8, further comprising:
slots adjacent each of the read/write elements on the data island.

12. A method comprising:
providing a data island for a read/write head that writes to a magnetic tape;
providing read/write elements on the data island; and
forming the data island to reduce contact between the magnetic tape and the data island at locations between the read/write elements.

13. The method of claim 12, further comprising:
forming slots on the data island between the read/write elements through one of:
removing material from between the read/write elements; and
coating the data island with material and removing the material between the read/write elements.

14. The method of claim 12, further comprising:
forming at least one of rounded edges and chamfered edges on the data island between the read/write elements; and
providing sharp edges on the data island at the read/write elements.

15. The method of claim 12, further comprising:
forming slots by cutting slots between the read/write elements.
